(19) United States
(12) Patent Application Publication
(10) Pub. No.: US 2023/0134942 A1
(43) Pub. Date: May 4, 2023

(54) APPARATUS AND METHOD FOR SELF-SUPERVISED TRAINING OF END-TO-END SPEECH RECOGNITION MODEL

(71) Applicant: ELECTRONICS AND TELECOMMUNICATIONS RESEARCH INSTITUTE, Daejeon (KR)

(72) Inventors: Hoon CHUNG, Daejeon (KR); Byung-Ok KANG, Daejeon (KR); Jeom-Ja KANG, Daejeon (KR); Yun-Kyung LEE, Sejong-si (KR); Hyung-Bae JEON, Daejeon (KR)

(73) Assignee: ELECTRONICS AND TELECOMMUNICATIONS RESEARCH INSTITUTE, Daejeon (KR)

(21) Appl. No.: 17/961,830

(22) Filed: Oct. 7, 2022

(30) Foreign Application Priority Data
Nov. 1, 2021 (KR) 10-2021-0148044

(51) Int. Cl. G10L 15/06; G10L 15/187

(52) U.S. Cl. CPC G10L 15/063; G10L 15/187

(57) ABSTRACT

Disclosed herein are an apparatus and method for self-supervised training of an end-to-end speech recognition model. The apparatus includes memory in which at least one program is recorded and a processor for executing the program. The program trains an end-to-end speech recognition model, including an encoder and a decoder, using untranscribed speech data. The program may add predetermined noise to the input signal of the end-to-end speech recognition model, and may calculate loss by reflecting a predetermined constraint based on the output of the encoder of the end-to-end speech recognition model.

### CROSS REFERENCE TO RELATED APPLICATION

This application claims the benefit of Korean Patent Application No. 10-2021-0148044, filed Nov. 1, 2021, which is hereby incorporated by reference in its entirety into this application.

### BACKGROUND OF THE INVENTION

### 1. Technical Field

The disclosed embodiment relates to technology for training an end-to-end speech recognition system.

### 2. Description of the Related Art

A speech recognition system based on a traditional probability model represents speech information and language information as individual probability models, so it has high system complexity and has difficulty in representing knowledge on the link between a language and speech. In contrast, an end-to-end speech recognition system uses a single deep-neural network, so it has advantages in that it is able to represent information about the link between a language and speech and to decrease system complexity.

Generally, an end-to-end speech recognition model learns acoustic, speech, and linguistic variations required for speech recognition using transcription data configured with paired speech and text. Accordingly, a large amount of transcription data including various changes is required for robust modeling. However, it takes a lot of expense, time and effort to collect a large amount of transcription data, and the lack of transcription data is regarded as one of the biggest problems in research on end-to-end speech recognition.

Accordingly, as a method for reducing such effort and expense, methods for advancing an end-to-end speech recognition model using only untranscribed speech data are receiving a lot of attention.

### SUMMARY OF THE INVENTION

An object of the disclosed embodiment is to advance an end-to-end speech recognition model through training using only untranscribed speech data.

Another object of the disclosed embodiment is to enable an encoder to learn a meaningful expression for a speech signal by making the encoder learn a meaningful linguistic latent space.

An apparatus for self-supervised training of an end-to-end speech recognition model according to an embodiment includes memory in which at least one program is recorded and a processor for executing the program. The program may train an end-to-end speech recognition model, including an encoder and a decoder, using untranscribed speech data, add predetermined noise to an input signal of the end-to-end speech recognition model, and calculate a loss by reflecting a predetermined constraint based on the output of the encoder of the end-to-end speech recognition model.

Here, the end-to-end speech recognition model may include a vector quantization layer.

Here, the program may repeatedly update parameters of the end-to-end speech recognition model such that the loss between the output value of the end-to-end speech recognition model and a predetermined target value is minimized.

Here, the predetermined target value may be defined as a speech signal of a frame that is n frames before the current frame input to the end-to-end speech recognition model (n being a natural number).

Here, the predetermined constraint may be calculated based on a linguistic unit generated from the output of the encoder.

Here, the linguistic unit may be a phoneme or a syllable.

Here, the predetermined constraint may be defined as a function for measuring the similarity between a probability of the linguistic unit generated from the output of the encoder and a distribution of a unit based on a sequence of linguistic units generated from the output of the encoder.

A method for self-supervised training of an end-to-end speech recognition model according to an embodiment includes adding predetermined noise to untranscribed speech data, inputting the untranscribed speech data, to which the predetermined noise is added, to an end-to-end speech recognition model including an encoder and a decoder, calculating a loss between the output value of the end-to-end speech recognition model and a predetermined target value, and updating parameters of the end-to-end speech recognition model such that the calculated loss is minimized. When calculating the loss is performed, the loss may be calculated by reflecting a predetermined constraint based on the output of the encoder of the end-to-end speech recognition model.

Here, the end-to-end speech recognition model may include a vector quantization layer.

Here, the predetermined target value may be defined as a speech signal of a frame that is n frames before the current frame input to the end-to-end speech recognition model (n being a natural number).

Here, the predetermined constraint may be calculated based on a linguistic unit generated from the output of the encoder.

Here, the linguistic unit may be a phoneme or a syllable.

Here, the predetermined constraint may be defined as a function for measuring the similarity between a probability of the linguistic unit generated from the output of the encoder and a distribution of a unit based on a sequence of linguistic units generated from the output of the encoder.

The disclosed embodiment is a computer-readable recording medium in which program code for performing the above-described method for self-supervised training of an end-to-end speech recognition model is stored.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a schematic block diagram of an apparatus for self-supervised training of an end-to-end speech recognition model using a VQ-APC method;

FIG. 2 is an exemplary view of an end-to-end speech recognition model;

FIG. 3 is a schematic block diagram of an apparatus for self-supervised training of an end-to-end speech recognition model according to an embodiment;

FIG. 4 is a flowchart for explaining a method for self-supervised training of an end-to-end speech recognition model according to an embodiment; and

FIG. 5 is a view illustrating a computer system configuration according to an embodiment.

### DESCRIPTION OF THE PREFERRED EMBODIMENTS

The advantages and features of the present invention and methods of achieving them will be apparent from the following exemplary embodiments to be described in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

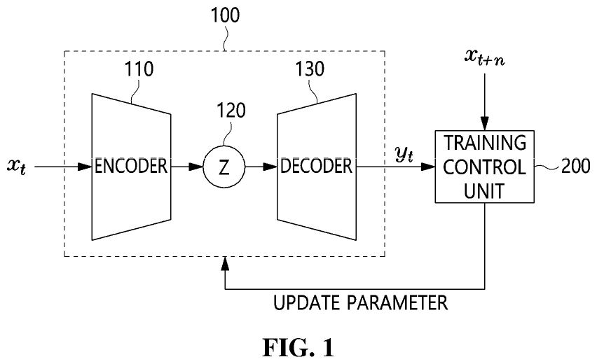

Hereinafter, an apparatus and method for self-supervised training of an end-to-end speech recognition model according to an embodiment will be described in detail with reference to FIGS. 1 to 5.

As explained in the description of the related art, methods for training an end-to-end speech recognition model using untranscribed speech data may be used in order to solve the problem with the training method using transcription speech data, and among these methods, the most representative method is a self-supervised training method.

Self-supervised training is a method of appropriately defining a pair comprising an input and a target for untranscribed speech data and performing supervised training. Accordingly, depending on the method of defining an ‘input’ and a ‘target’ and on the method of defining a “loss function” between the prediction value and the target value of a model, various types of self-supervised training are possible. With regard to training of an end-to-end speech recognition model based on self-supervised training, an Autoregressive Predictive Coding (APC) method and a Vector-Quantized (VQ) APC method, which is a quantized version of the APC method, are widely used in order to train the encoder of the end-to-end speech recognition model by defining an arbitrary supervised training task for untranscribed speech data.

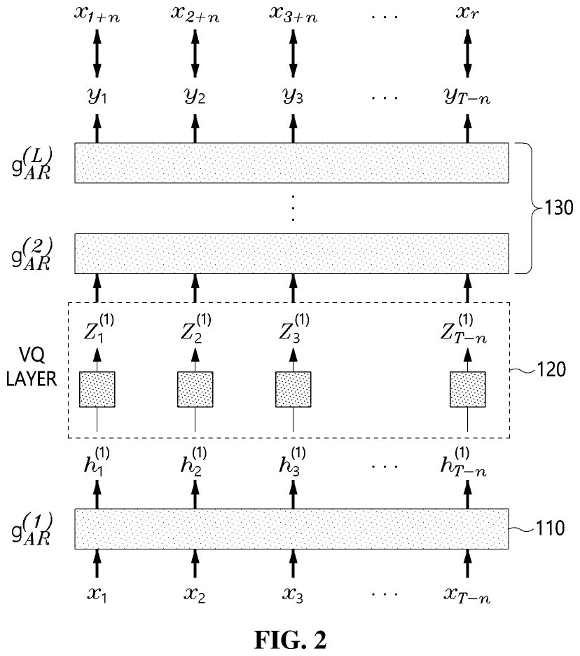

FIG. 1 is a schematic block diagram of an apparatus for self-supervised training of an end-to-end speech recognition model using a VQ-APC method, and FIG. 2 is an exemplary view of an end-to-end speech recognition model.

Referring to FIG. 1, the apparatus for self-supervised training of an end-to-end speech recognition model may include an end-to-end speech recognition model 100 and a training control unit 200 for training the end-to-end speech recognition model 100.

Here, referring to FIG. 2, the speech recognition model 100 is a deep-learning-based model for converting a speech signal uttered by a human into a text string, and predicts a text string Y*=y₁, y₂, . . . , y_{N} in response to an input speech feature vector sequence X=x₁, x₂, . . . , x_{T}.

To this end, the speech recognition model 100 includes an encoder 110 and a decoder 130.

Here, the output hₜ of the encoder 110 and the output yₜ of the decoder 130 for the input speech signal xₜ may be defined as shown in Equation (1) below:

hₜ=enc(xₜ)

yₜ=dec(hₜ) (1)

Additionally, the speech recognition model 100 may further include a VQ layer 120 for quantizing an encoded vector such that the encoded output hₜ maintains only important information required for prediction.

Because the VQ-APC end-to-end speech recognition model 100 is trained using untranscribed speech data, the (input, output) pair of training data using untranscribed speech data may be defined as (the speech signal xₜ of the current frame, the speech signal xₜ₊ₙ of the frame n frames before the current frame).

Accordingly, for the speech signal xₜ of the current frame of the end-to-end speech recognition model 100, the training control unit 200 calculates the prediction error of the output signal yₜ, that is, the loss L1, as the difference between the output signal yₜ and the speech signal xₜ₊ₙ of the frame n frames before the current frame, as shown in Equation (2) below, and trains the end-to-end speech recognition model 100 such that the difference is minimized.

$${L}_{APC} = {{\sum }^{T - k}}_{t = 1} \vert {x}_{t + k} - {y}_{t} \vert \qquad ( 2 )$$

In an end-to-end speech recognition model based on an encoder and a decoder, the encoder is generally regarded as converting a signal of a frequency space into a linguistic space. However, the existing APC method sets no constraints on the output of the encoder, so there is no correlation between the output of the encoder and the linguistic space.

In order to improve this, an embodiment is configured to add a predetermined constraint such that the output of the encoder is correlated with the linguistic space, thereby performing training such that the encoder outputs a more meaningful result from the aspect of linguistics.

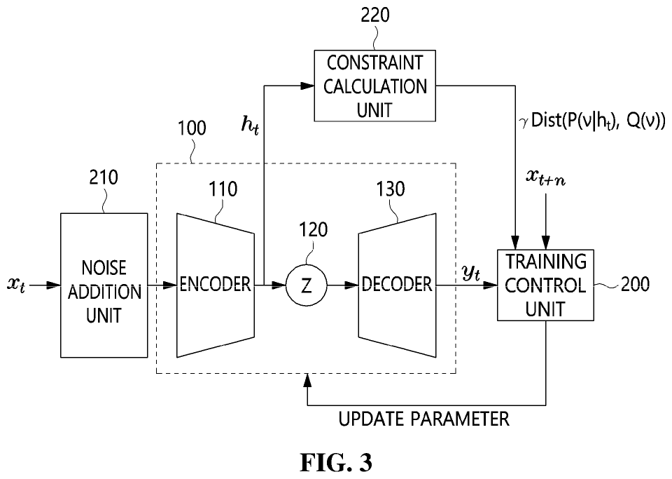

FIG. 3 is a schematic block diagram of an apparatus for self-supervised training of an end-to-end speech recognition model according to an embodiment.

Referring to FIG. 3, the apparatus for self-supervised training of an end-to-end speech recognition model according to an embodiment may include an end-to-end speech recognition model 100, a training control unit 200, a noise addition unit 210, and a constraint calculation unit 220.

Here, the end-to-end speech recognition model 100 may have the same configuration as the configuration described above with reference to FIG. 1 and FIG. 2, and thus a detailed description thereof will be omitted.

According to an embodiment, the noise addition unit 210 is further included on the input side of the end-to-end speech recognition model 100, whereby predetermined noise may be added to a speech signal input to the encoder 110. Accordingly, the output signal of the encoder 110 may be calculated as shown in Equation (3) below:

hₜ=enc(α(xₜ)) (3)

In Equation (3), α( ) adds noise to the input speech signal xₜ in consideration of label consistency. Accordingly, in an embodiment, a certain level of additional channel noise is added to the input speech signal xₜ, whereby the original signal is distorted. That is, using a label consistency method, the model is made robust to perturbation.

Meanwhile, the training control unit 200 may repeatedly update the parameters of the end-to-end speech recognition model 100 such that the loss between the output value of the end-to-end speech recognition model 100 and a predetermined prediction value is minimized.

Here, the predetermined prediction value may be defined as the speech signal of a frame that is n frames before the current frame input to the end-to-end speech recognition model 100 (n being a natural number).

That is, because the end-to-end speech recognition model 100 is trained using untranscribed speech data, the (input, output) pair of training data is defined as (the speech signal xₜ of the current frame, the speech signal xₜ₊ₙ of the frame n frames before the current frame).

Accordingly, for the speech signal xₜ of the current frame of the end-to-end speech recognition model 100, the training control unit 200 calculates the prediction error of the output signal yₜ as the difference between the output signal yₜ and the speech signal xₜ₊ₙ of the frame n frames before the current frame, and trains the end-to-end speech recognition model 100 such that the difference is minimized.

Here, the training control unit 200 according to an embodiment may calculate the loss by reflecting a predetermined constraint based on the output of the encoder 110 of the end-to-end speech recognition model 100, which is calculated by the constraint calculation unit 220.

Here, the predetermined constraint may be calculated based on a linguistic unit generated from the output of the encoder 110. Here, the linguistic unit may be a phoneme or a syllable.

That is, the training control unit 200 according to an embodiment may use a loss function like what is shown in Equation (4) below:

$${z}_{t} \sim P ( V \vert {h}_{t} ) = softmax ( Linear ( {h}_{t} ) ) \qquad ( 4 )$$

$${y}_{t} = dec ( {z}_{t} )$$

$${L}_{DC - APC} = {{\sum }^{T - k}}_{t = 1} \vert {x}_{t + k} - {y}_{t} \vert + γ Dist ( P ( V \vert {h}_{t} ) , Q ( V ) )$$

Referring to Equation (4), the predetermined constraint γDist(P(V|hₜ), Q(V)) for the output hₜ of the encoder is reflected in the loss function.

That is, in Equation (4), V is a linguistic unit, and may be a phoneme or a syllable, and Q(V) may be the distribution of the linguistic unit. Also, Dist( ) is a function for measuring the similarity between two probability distributions. That is, a constraint is set such that a sequence V of phonemes or syllables generated from the output hₜ of the encoder has the distribution of the units represented as Q(V).

That is, in the embodiment, the predetermined constraint is added such that the output of the encoder is correlated with a linguistic space, whereby training is performed such that the encoder outputs a more meaningful result in terms of linguistics.

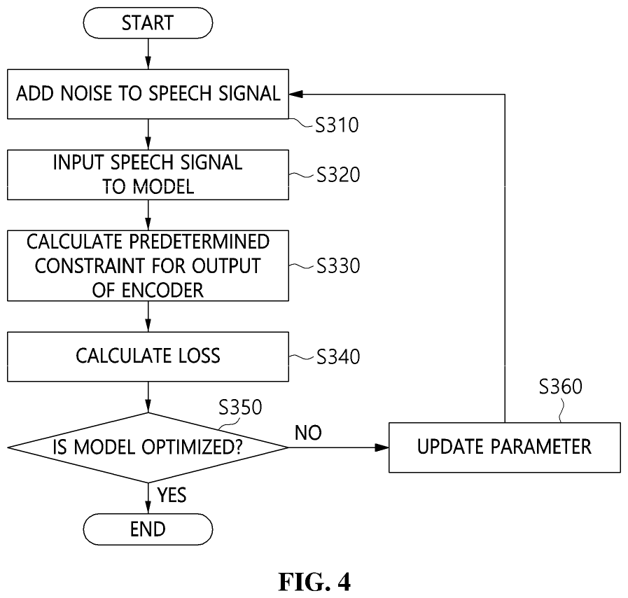

FIG. 4 is a flowchart for explaining a method for self-supervised training of an end-to-end speech recognition model according to an embodiment.

Referring to FIG. 4, the method for self-supervised training of an end-to-end speech recognition model according to an embodiment includes adding predetermined noise to untranscribed speech data at step S310, inputting the untranscribed speech data, to which the predetermined noise is added, to an end-to-end speech recognition model including an encoder and a decoder at step S320, calculating the loss between the output value of the end-to-end speech recognition model and a predetermined prediction value at step S340, and updating the parameters of the end-to-end speech recognition model such that the calculated loss is minimized at steps S350 to S360. When the loss is calculated, a predetermined constraint based on the output of the encoder of the end-to-end speech recognition model is calculated at step S330, and the loss may be calculated based in part on the calculated predetermined constraint.

Here, the end-to-end speech recognition model may include a vector quantization layer.

Here, the predetermined prediction value may be defined as the speech signal of a frame that is n frames before the current frame input to the end-to-end speech recognition model (n being a natural number).

Here, the predetermined constraint may be calculated based on a linguistic unit generated from the output of the encoder.

Here, the linguistic unit may be a phoneme or a syllable.

Here, the predetermined constraint may be defined as a function for measuring similarity between the probability of the linguistic unit generated from the output of the encoder and the distribution of a unit based on a sequence of linguistic units generated from the output of the encoder.

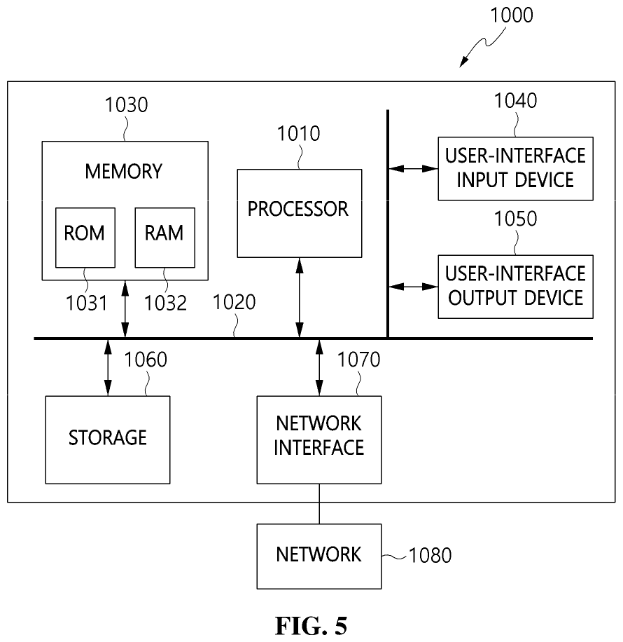

FIG. 5 is a view illustrating a computer system configuration according to an embodiment.

The apparatus for self-supervised training of an end-to-end speech recognition model according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, an end-to-end speech recognition model may be advanced through training using only untranscribed speech data.

According to the disclosed embodiment, the output value of an encoder is limited using linguistic information such that the encoder learns a meaningful latent space, whereby the encoder may learn a meaningful expression for a speech signal.

Although embodiments of the present invention have been described with reference to the accompanying drawings, those skilled in the art will appreciate that the present invention may be practiced in other specific forms without changing the technical spirit or essential features of the present invention. Therefore, the embodiments described above are illustrative in all aspects and should not be understood as limiting the present invention.

What is claimed is:

1. An apparatus for self-supervised training of an end-to-end speech recognition model, comprising:
memory in which at least one program is recorded; and
a processor for executing the program,
wherein the program
trains an end-to-end speech recognition model, including an encoder and a decoder, using untranscribed speech data,
adds predetermined noise to an input signal of the end-to-end speech recognition model, and
calculates a loss by reflecting a predetermined constraint based on output of the encoder of the end-to-end speech recognition model.

2. The apparatus of claim 1, wherein the end-to-end speech recognition model includes a vector quantization layer.

3. The apparatus of claim 1, wherein the program repeatedly updates parameters of the end-to-end speech recognition model such that a loss between an output value of the end-to-end speech recognition model and a predetermined target value is minimized.

4. The apparatus of claim 3, wherein the predetermined target value is defined as a speech signal of a frame that is n frames before a current frame input to the end-to-end speech recognition model (n being a natural number).

5. The apparatus of claim 1, wherein the predetermined constraint is calculated based on a linguistic unit generated from the output of the encoder.

6. The apparatus of claim 5, wherein the linguistic unit is a phoneme or a syllable.

7. The apparatus of claim 5, wherein the predetermined constraint is defined as a function for measuring a similarity between a probability of the linguistic unit generated from the output of the encoder and a distribution of a unit based on a sequence of linguistic units generated from the output of the encoder.

8. A method for self-supervised training of an end-to-end speech recognition model, comprising:
adding predetermined noise to untranscribed speech data;
inputting the untranscribed speech data, to which the predetermined noise is added, to an end-to-end speech recognition model including an encoder and a decoder;
calculating a loss between an output value of the end-to-end speech recognition model and a predetermined target value; and
updating parameters of the end-to-end speech recognition model such that the calculated loss is minimized,
wherein, when calculating the loss is performed, the loss is calculated by reflecting a predetermined constraint based on output of the encoder of the end-to-end speech recognition model.

9. The method of claim 8, wherein the end-to-end speech recognition model includes a vector quantization layer.

10. The method of claim 8, wherein the predetermined target value is defined as a speech signal of a frame that is n frames before a current frame input to the end-to-end speech recognition model (n being a natural number).

11. The method of claim 8, wherein the predetermined constraint is calculated based on a linguistic unit generated from the output of the encoder.

12. The method of claim 11, wherein the linguistic unit is a phoneme or a syllable.

13. The method of claim 8, wherein the predetermined constraint is defined as a function for measuring a similarity between a probability of the linguistic unit generated from the output of the encoder and a distribution of a unit based on a sequence of linguistic units generated from the output of the encoder.

14. A computer-readable recording medium in which program code for performing a method for self-supervised training of an end-to-end speech recognition model is stored,
wherein:
the method for self-supervised training of an end-to-end speech recognition model includes
adding predetermined noise to untranscribed speech data,
inputting the untranscribed speech data, to which the predetermined noise is added, to an end-to-end speech recognition model including an encoder and a decoder,
calculating a loss between an output value of the end-to-end speech recognition model and a predetermined target value, and
updating parameters of the end-to-end speech recognition model such that the calculated loss is minimized, and
when calculating the loss is performed, the loss is calculated by reflecting a predetermined constraint based on output of the encoder of the end-to-end speech recognition model.

15. The computer-readable recording medium of claim 14, wherein the end-to-end speech recognition model includes a vector quantization layer.

16. The computer-readable recording medium of claim 14, wherein the predetermined target value is defined as a speech signal of a frame that is n frames before a current frame input to the end-to-end speech recognition model (n being a natural number).

17. The computer-readable recording medium of claim 14, wherein the predetermined constraint is calculated based on a linguistic unit generated from the output of the encoder.

18. The computer-readable recording medium of claim 17, wherein the linguistic unit is a phoneme or a syllable.

19. The computer-readable recording medium of claim 17, wherein the predetermined constraint is defined as a function for measuring a similarity between a probability of the linguistic unit generated from the output of the encoder and a distribution of a unit based on a sequence of linguistic units generated from the output of the encoder.
